(19) United States
(12) Patent Application Publication
(10) Pub. No.: US 2025/0086141 A1
(43) Pub. Date: Mar. 13, 2025

(54) TECHNIQUES FOR TRACKING FILE SYSTEM UTILIZATION BY SOFTWARE APPLICATIONS

(71) Applicant: Apple Inc., Cupertino, CA (US)

(72) Inventors: Meha N. DESAI, Palo Alto, CA (US); Eric B. TAMURA, Sunnyvale, CA (US); Cameron S. BIRSE, San Jose, CA (US); Jason R. THORPE, San Francisco, CA (US); Madhuree DAYANAND, Mountain View, CA (US); Yair SCHIFF, Rehovot (IL); Oded SHOSHANI, Azmon (IL); Idan FISCHMAN, Nesher (IL)

(21) Appl. No.: 18/540,699

(22) Filed: Dec. 14, 2023

Related U.S. Application Data
(60) Provisional application No. 63/581,939, filed on Sep. 11, 2023.

(51) Int. Cl. G06F 16/13; G06F 16/17

(52) U.S. Cl. CPC G06F 16/13; G06F 16/1734

(57) ABSTRACT

Disclosed herein are techniques for tracking file system (FS) utilization by a plurality of applications. According to some embodiments, a technique can be implemented by a computing device on which the FS is implemented, and includes the steps of (1) receiving, from an application among the plurality of applications, a request to perform an input/output (I/O) operation pertaining to a first FS object, where the request includes a unique identifier (ID) associated with the application, (2) creating or locating, within the FS, the first FS object, (3) performing the I/O operation against the first FS object, (4) creating or locating, within the FS, a second FS object associated with the unique ID, and (5) updating the second FS object to reflect the I/O operation. Other techniques include observing, analyzing, etc., FS utilization by the plurality of applications.

### CROSS-REFERENCE TO RELATED APPLICATIONS

The present application claims the benefit of U.S. Provisional Application No. 63/581,939, entitled “TECHNIQUES FOR TRACKING FILE SYSTEM UTILIZATION BY SOFTWARE APPLICATIONS,” filed Sep. 11, 2023, the content of which is incorporated by reference herein in its entirety for all purposes.

### FIELD

The described embodiments relate generally to techniques for tracking file system utilization by software applications. More particularly, the described embodiments provide techniques for maintaining records that identify the extent to which software applications are interacting with files located outside of the designated operating directories of the software applications.

### BACKGROUND

Software applications that write data to areas outside of their designated operating directories pose significant security and stability concerns. This problem arises when software applications, intentionally or unintentionally, access files, configurations, etc., in locations beyond their designated operating directories. For the reasons discussed below, this practice can have far-reaching consequences, which can include compromising system security, causing software conflicts, and raising challenges with respect to maintaining a clean and organized computing environment.

First, when software applications write data to locations outside of their designated operating directories, it can introduce security vulnerabilities. This is particularly worrisome because it can enable malicious software to access, manipulate, etc., sensitive system files, which can potentially lead to data breaches, system compromises, and unauthorized access. For example, unauthorized modifications to system files can jeopardize the integrity and confidentiality of user data, thereby creating substantial security risks.

Second, when software applications write data outside of their designated operating directories, it can disrupt system stability. In particular, these actions can introduce conflicts between different software applications, as they may inadvertently overwrite or interfere with each other's files, configurations, and so on. Such conflicts can lead to software application crashes, system errors, and an overall unstable computing environment.

Additionally, managing and maintaining a system becomes challenging when software applications scatter their data across various locations. In particular, such activity can make it difficult to identify and uninstall software applications in a comprehensive fashion, as remnants of the software applications may linger in unexpected locations. This can lead to resource utilization inefficiencies, given unused or outdated files continue to occupy valuable storage space.

To mitigate these issues, software developers should adhere to best practices when designing their software applications. In particular, software developers should limit the scope of where their software applications can write data to ensure that it remains within their designated operating directories. Unfortunately, enforcing and/or implementing such requirements can be challenging for a variety of reasons. For example, it can be difficult for software developers to identify all data with which their software applications have been designed to interact. Moreover, it can be difficult to identify software developers that intentionally develop software applications that interact with data outside of their designated operating directories.

Accordingly, what is needed are techniques for tracking the manner in which software applications utilize file systems to ensure that the software applications do not interact with data stored outside of their designated operating directories.

### SUMMARY

The described embodiments relate generally to techniques for tracking file system utilization by software applications. More particularly, the described embodiments provide techniques for maintaining records that identify the extent to which software applications are interacting with files located outside of the designated operating directories of the software applications.

One embodiment sets forth a method for tracking file system (FS) utilization by a plurality of applications. According to some embodiments, the method can be implemented by a computing device on which the FS is implemented, and includes the steps of (1) receiving, from an application among the plurality of applications, a request to perform an input/output (I/O) operation pertaining to a first FS object, where the request includes a unique identifier (ID) associated with the application, (2) creating or locating, within the FS, the first FS object, (3) performing the I/O operation against the first FS object, (4) creating or locating, within the FS, a second FS object associated with the unique ID, and (5) updating the second FS object to reflect the I/O operation.

Another embodiment sets forth a method for observing file system (FS) utilization by one or more applications. According to some embodiments, the method can be implemented by a computing device on which the FS is implemented, and includes the steps of (1) receiving a request to display FS utilization metrics associated with the one or more applications, where each application of the one or more applications is associated with a respective unique identifier (ID), (2) for each application of the one or more applications: locating, within the FS, a respective FS object that (i) is associated with the respective unique ID, and (ii) includes respective aggregated FS utilization metrics associated with the application, and generating a respective FS utilization affordance based on the respective aggregated FS utilization metrics, and (3) outputting a user interface (UI) that includes one or more of the FS utilization affordances.

Yet another embodiment sets forth a method for analyzing file system (FS) utilization by one or more applications. According to some embodiments, the method can be implemented by a computing device on which the FS is implemented, and includes the steps of (1) receiving, from an entity, a request to access FS utilization metrics associated with a particular application of the one or more applications, where the particular application is associated with a respective unique identifier (ID), (2) locating, within the FS, a respective FS object that (i) is associated with the respective unique ID, and (ii) includes respective aggregated FS utilization metrics associated with the particular application, (3) performing at least one operation against the respective FS object to generate at least one result, and (4) providing the at least one result to the entity.

Other embodiments include a non-transitory computer readable storage medium configured to store instructions that, when executed by a processor included in a computing device, cause the computing device to carry out the various steps of any of the foregoing methods. Further embodiments include a computing device that is configured to carry out the various steps of any of the foregoing methods.

Other aspects and advantages of the embodiments described herein will become apparent from the following detailed description taken in conjunction with the accompanying drawings which illustrate, by way of example, the principles of the described embodiments.

### BRIEF DESCRIPTION OF THE DRAWINGS

The included drawings are for illustrative purposes and serve only to provide examples of possible structures and arrangements for the disclosed inventive apparatuses and methods for providing wireless computing devices. These drawings in no way limit any changes in form and detail that may be made to the embodiments by one skilled in the art without departing from the spirit and scope of the embodiments. The embodiments will be readily understood by the following detailed description in conjunction with the accompanying drawings, wherein like reference numerals designate like structural elements.

FIG. 1 illustrates a block diagram of different components of a system that can be configured to implement the various techniques described herein, according to some embodiments.

FIGS. 2A-2M illustrate conceptual diagrams of an example sequence of interactions between applications, a file system manager, and files/application file records, according to some embodiments.

FIGS. 3A-3D illustrate conceptual diagrams of example user interfaces that can be provided by a storage space management application, according to some embodiments.

FIG. 4 illustrates a method for tracking file system (FS) utilization by a plurality of applications, according to some embodiments.

FIG. 5 illustrates a method for observing FS utilization by one or more applications, according to some embodiments.

FIG. 6 illustrates a method for analyzing FS utilization by one or more applications, according to some embodiments.

FIG. 7 illustrates a detailed view of a computing device that can be used to implement the various components described herein, according to some embodiments.

### DETAILED DESCRIPTION

Representative applications of apparatuses and methods according to the presently described embodiments are provided in this section. These examples are being provided solely to add context and aid in the understanding of the described embodiments. It will thus be apparent to one skilled in the art that the presently described embodiments can be practiced without some or all of these specific details. In other instances, well known process steps have not been described in detail in order to avoid unnecessarily obscuring the presently described embodiments. Other applications are possible, such that the following examples should not be taken as limiting.

The described embodiments relate generally to techniques for tracking file system utilization by software applications. More particularly, the described embodiments provide techniques for maintaining records that identify the extent to which software applications are interacting with files located outside of the designated operating directories of the software applications.

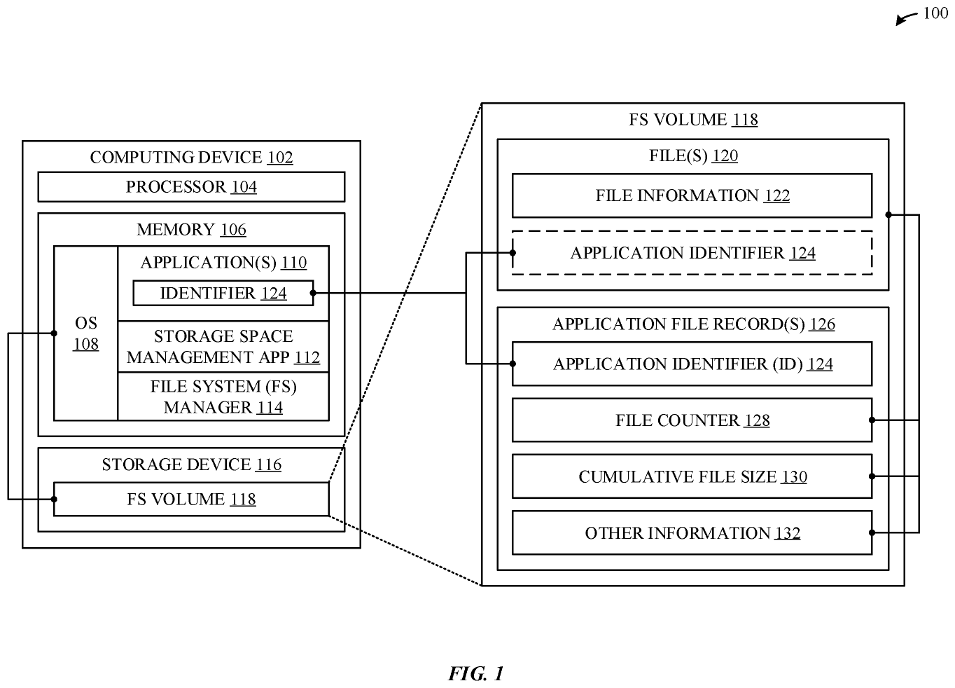

FIG. 1 illustrates a block diagram of a system 100 that can be configured to implement various aspects of the techniques described herein, according to some embodiments. Specifically, FIG. 1 illustrates a high-level overview of a computing device 102, which, as shown, can include at least one processor 104, at least one memory 106, and at least one storage device 116. According to some embodiments, the computing device 102 can represent any form of a computing device, e.g., a personal computing device, a smartphone computing device, a tablet computing device, a laptop computing device, a desktop computing device, a rack-mounted computing device, a gaming computing device, and so on. It is noted that the foregoing examples are not meant to be limiting, and that the computing device 102 can represent any form, type, etc., of computing device, without departing from the scope of this disclosure.

According to some embodiments, the processor 104 can be configured to operate in conjunction with the memory 106 and the storage device 116 to enable the computing device 102 to implement the various techniques set forth in this disclosure. According to some embodiments, the storage device 116 can represent a storage device that is accessible to the computing device 102, e.g., a hard drive, a solid-state drive (SSD), a mass storage device, a network storage device, a remote storage device, and the like. According to some embodiments, the storage device 116 can store at least one file system volume 118 that can be mounted for access by the computing device 102. For example, a file system volume 118 can include an OS 108 that is compatible with the computing device 102, another file system volume 118 can include user data, applications, etc., that are accessible via the OS 108, and so on. It is noted that the foregoing examples are not meant to be limiting, and that any number, type, form, etc., of file system volumes 118 can be stored on and accessible via the storage device 116, without departing from the scope of this disclosure.

According to some embodiments, the OS 108 can enable a variety of processes to execute on the computing device 102. The processes can include, for example, one or more applications 110, a storage space management application 112, and a file system manager 114. According to some embodiments, the file system manager 114 can be configured to execute within a “kernel space” of the OS 108, whereas the applications 110 and the storage space management application 112 can be configured to execute within a “user space” of the OS 108. For example, a given application 110 can represent an application that is native to the OS 108 (e.g., a contacts application, a telephone application, etc.). An application 110 that is native to the OS 108 constitutes a trusted entity that may have elevated privileges within the computing device 102 (at least relative to, for example, untrusted entities). In another example, a given application 110 can represent a third-party application (e.g., a social networking application, a banking application, etc.) that is indirectly installed on the computing device 102, such as an application 110 that is installed by way of a software application store (“app store”) application that is trusted by the computing device 102. In yet another example, a given application 110 can represent a third-party application (e.g., a hardware metrics application) that is directly installed on the computing device 102 without the use of a trusted app store application (commonly referred to as “side-loading”). It is noted that the foregoing examples are not meant to be limiting, and that any number, type, form, etc., of applications 110 can be installed on the computing device 102 without departing from the scope of this disclosure.

As a brief aside, and as discussed above, the OS 108, as well as the file system manager 114, can represent trusted entities within the computing device 102. It is noted that the trusted entities can also include software that is native to the OS 108 (such as one or more of the applications 110), software that originates from a trusted source (such as applications that are installed by way of an app store application that is trusted by the computing device 102), and so on. In this regard, a trusted entity is one which the computing device 102 has reason to believe originates from a trusted source and thus presents minimal risk of harming the computing device 102. As an example, trusted software can be confirmed through the use of signed certificates between the trusted software, the OS 108, hardware security devices with which the computing device 102 is communicatively coupled, and so on. In contrast, untrusted entities can be of unknown origin, such as applications 110 that are installed on the computing device 102 without oversight from an app store application that is trusted by the computing device (“side-loading”). Oftentimes, untrusted entities are of unknown provenance and quality, and, in some cases, can be riddled with bugs or malicious code. In this regard, untrusted software entities (such as one or more of the applications 110 illustrated in FIG. 1) can be restricted from accessing particular aspects of the computing device 102 (such as specific areas of the storage device 116, the file system volume(s) 118, the OS 108, the file system manager 114, etc.). Conversely, trusted software entities can be restricted from accessing untrusted software entities.

According to some embodiments, the file system manager 114 can be implemented as a kernel space process, such as a daemon. In particular, the file system manager 114 can be configured to manage input/output (I/O) operations issued by the applications 110, the storage space management application 112, and so on, against files 120 that are stored within a file system volume 118. As a brief aside, it is noted that the term “daemon” used herein can refer to any software, thread, process, etc., executing on the OS 108. A non-limiting example of a daemon is a process or program that runs as a background process on the OS 108 and that can wait for events or times to perform operations. In another non-limiting example, a daemon runs continuously on the OS 108 and exists for the purpose of handling periodic service requests that a computer system expects to receive, where the daemon program forwards the request to other programs/processes (e.g., such as those not illustrated in FIG. 1) as appropriate.

According to some embodiments, the I/O operations that the file system manager 114 can process can include, for example, create operations, delete operations, truncate operations, rename operations, read operations, write operations, append operations, open operations, close operations, rename operations, move operations, copy operations, list/enumerate operations, permissions/security modification operations, search operations, checksum/hashing operations, compression/decompression operations, symbolic/hard link operations, locking operations, synchronization operations, and so on. It is noted that the foregoing examples are not meant to be limiting, and that the file system manager 114 can be configured to implement any number, type, form, etc., of I/O operations, without departing from the scope of this disclosure.

As illustrated in FIG. 1, the file system volume 118 can include any number of files 120 (also referred to herein as “file system (FS) objects”). According to some embodiments, each file 120 can include file information 122, which can include any information that enables the file 120 to individually embody data within the file system volume 118. Such information can include, for example, metadata (e.g., a unique identifier associated with the file 120, name information associated with the file, tag information associated with the file, size information associated with the file 120, temporal information associated with the file 120, etc.), extent data (e.g., storage device 116 addresses, ranges, etc.) that identifies extents (not illustrated in FIG. 1) within the file system volume 118 that store the actual content of the file 120, and so on. It is noted that the foregoing examples are not meant to be limiting, and that each file 120 can store any form, type, amount, etc., of information, without departing from the scope of this disclosure.

Additionally, and as shown in FIG. 1, each file 120 can include an application identifier 124. As described herein, an application identifier 124 of a given file 120 can be used to store unique identifying information for applications 110 that issue I/O operations against the file 120 (e.g., via the file system manager 114). For example, when the file system manager 114 receives, from an application 110, a request to perform an I/O operation against a file 120, the file system manager 114 can effectively bind the application 110 and the file 120 by assigning the application identifier 124 of the application 110 to the application identifier 124 of the file 120. In this manner, the application identifiers 124 can enable the file system manager 114 to efficiently track and identify applications 110 that inappropriately issue I/O operations to files 120 that may be considered to be out of bounds relative to the respective operating directories of the applications 110. Moreover, because the application identifiers 124 can be assigned to files 120 any time the applications 110 issue I/O operations against the files 120, backward compatibility can be achieved even when the various features described herein are implemented after at least one file 120 has already been established within a given file system volume 118.

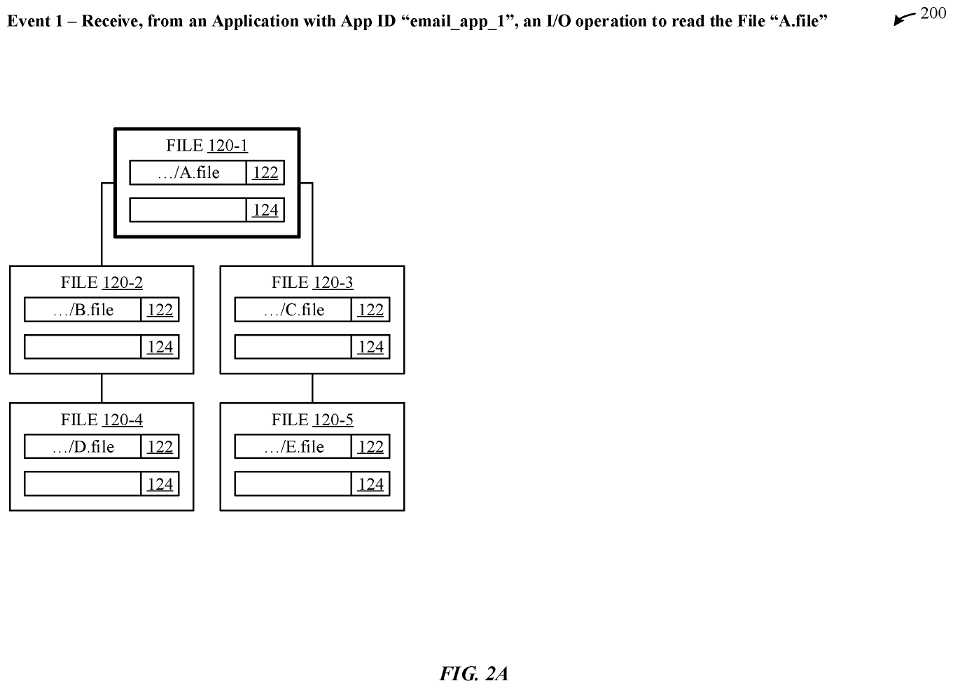

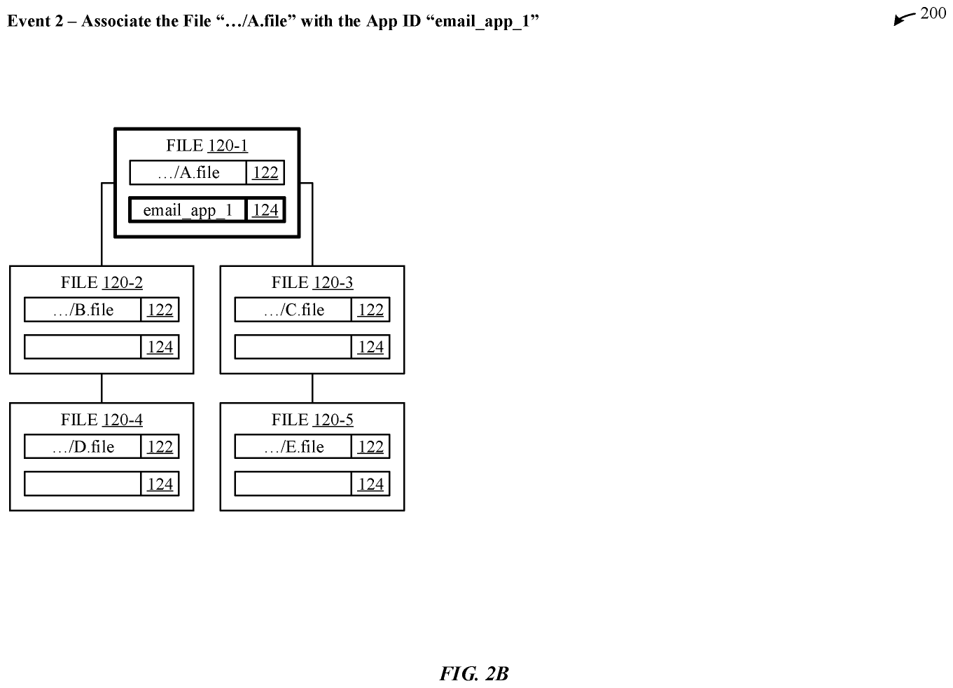

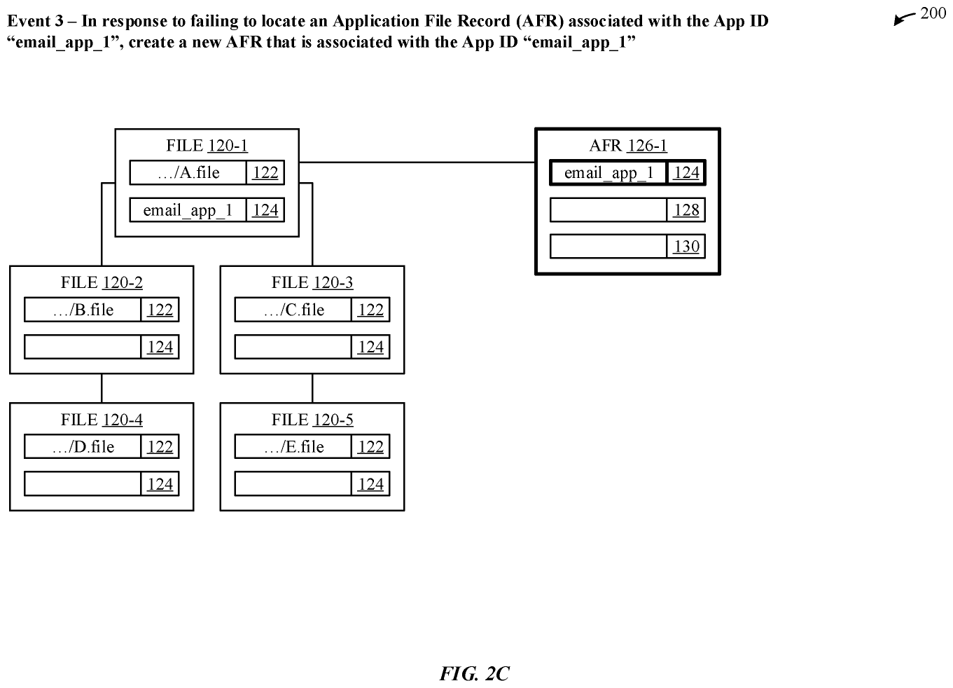

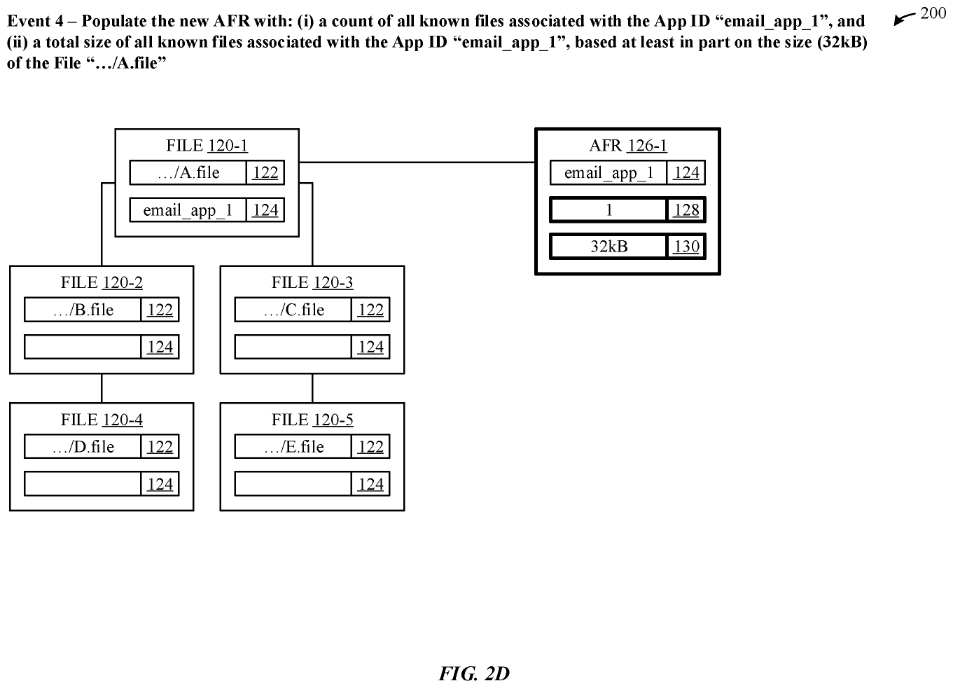

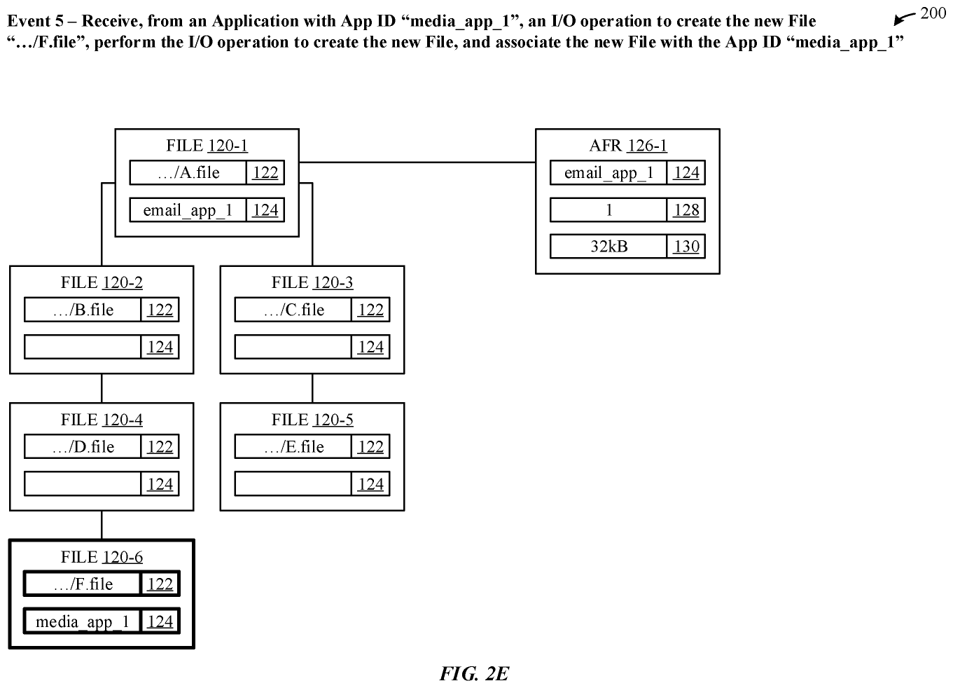

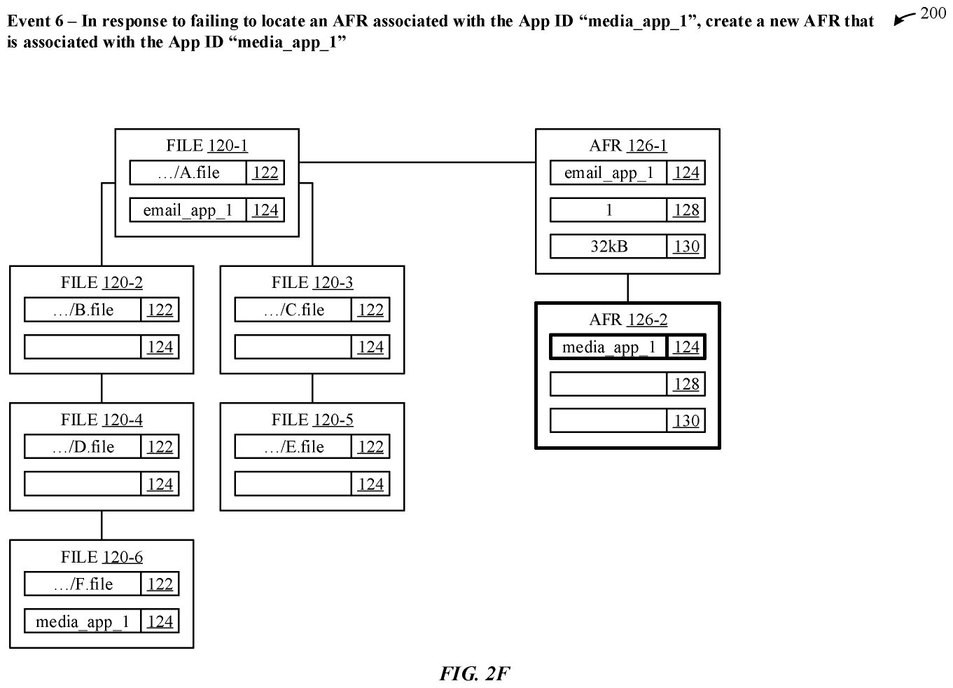

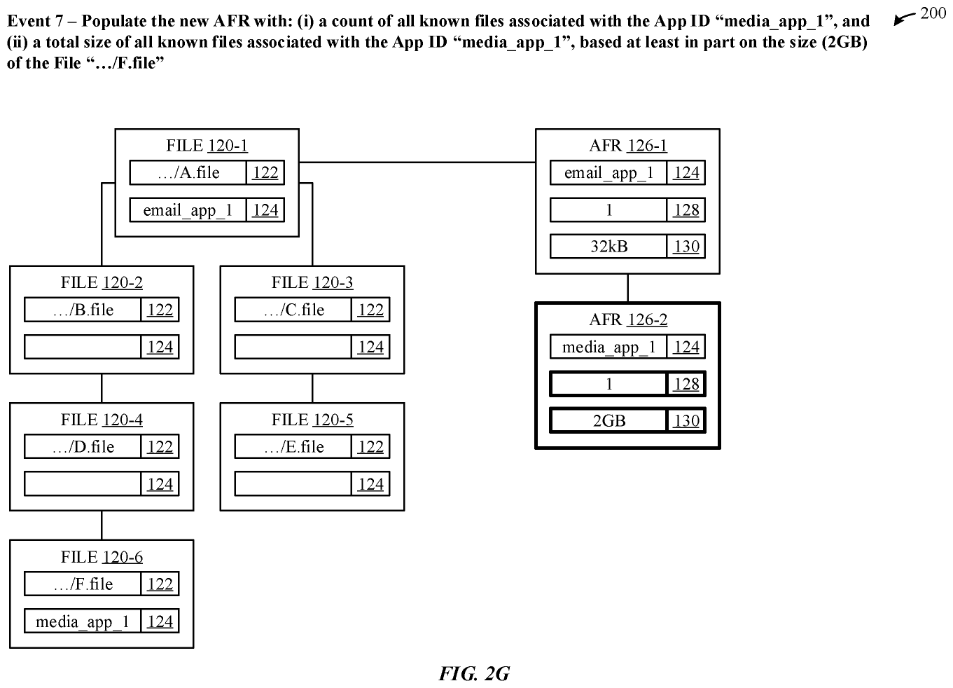

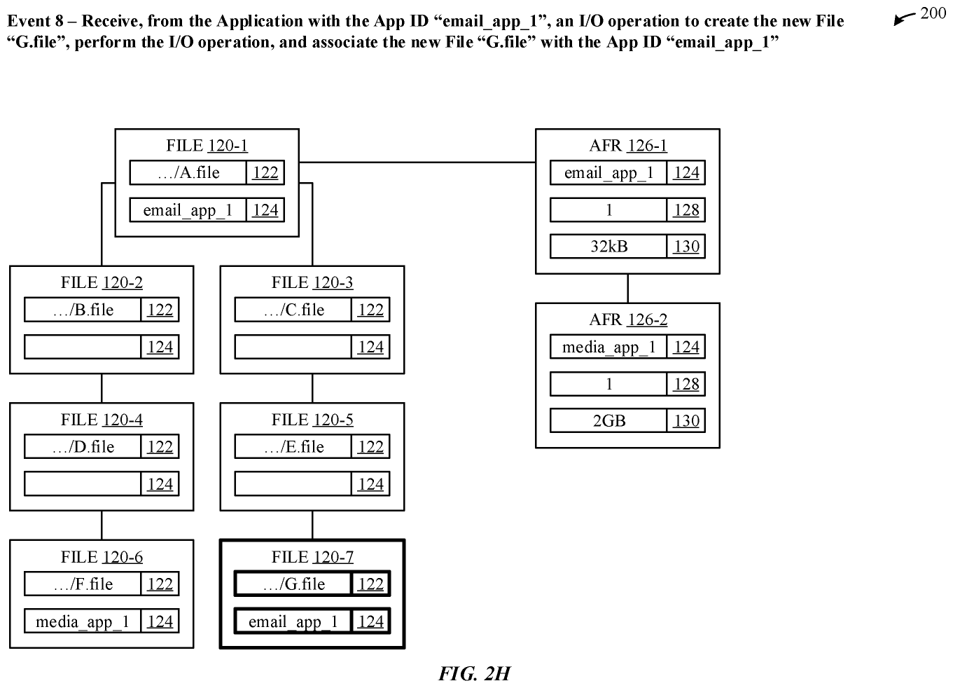

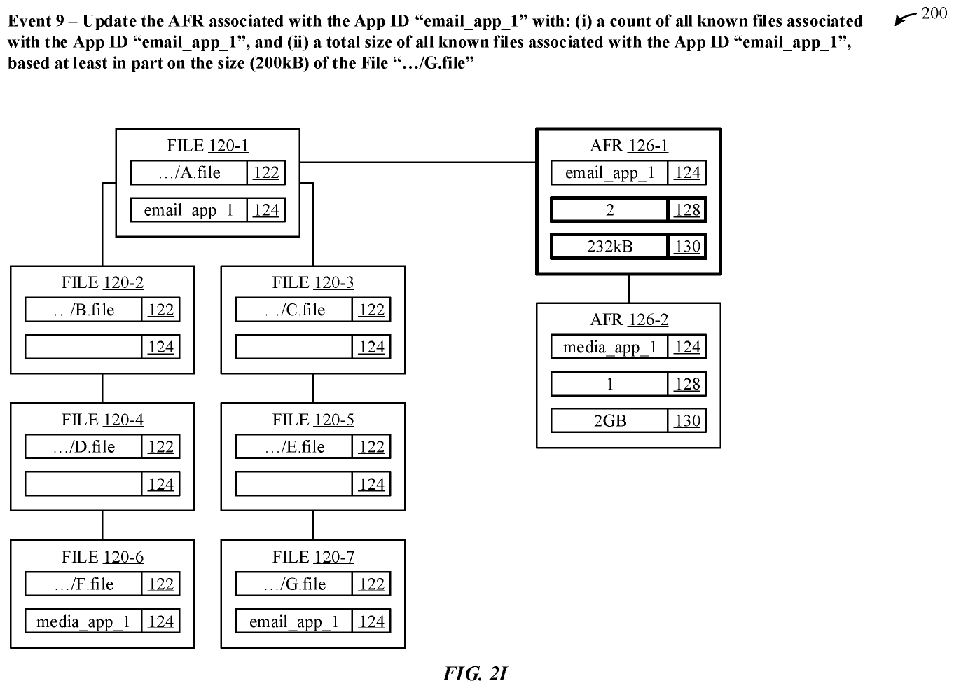

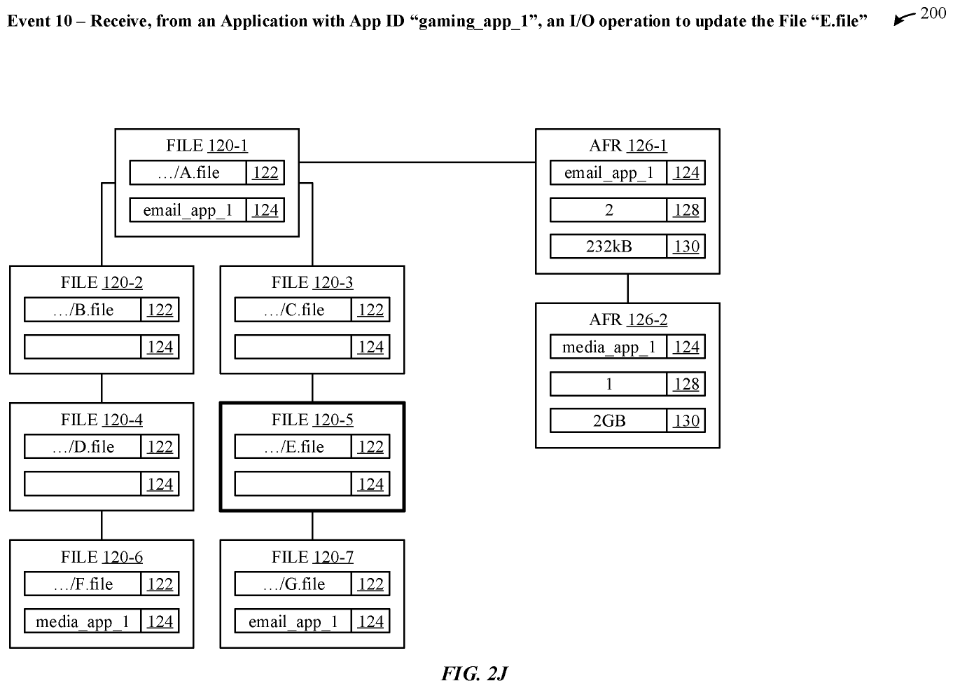

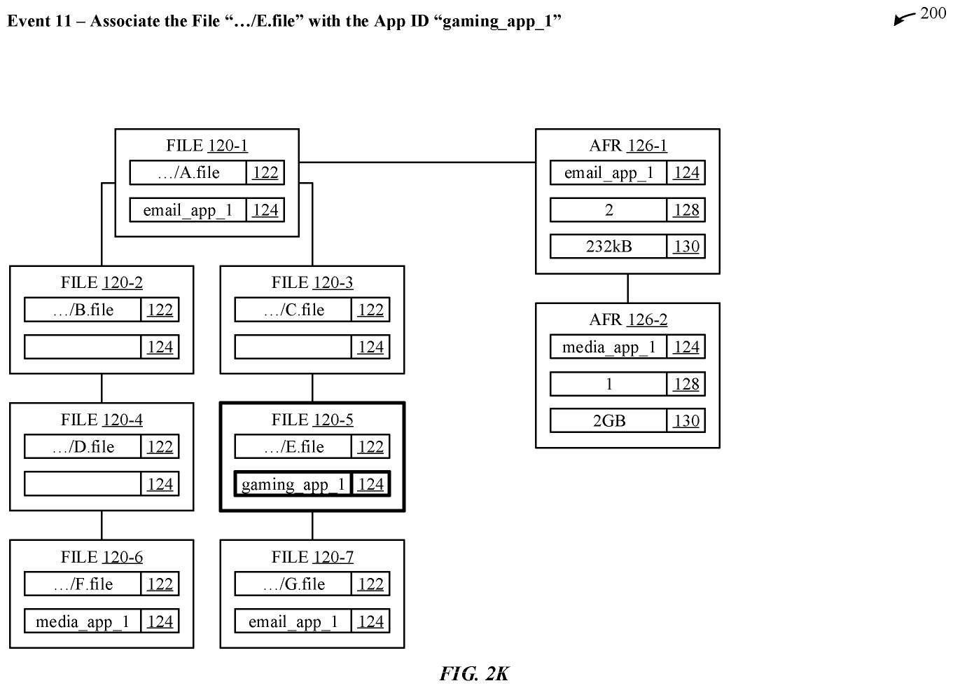

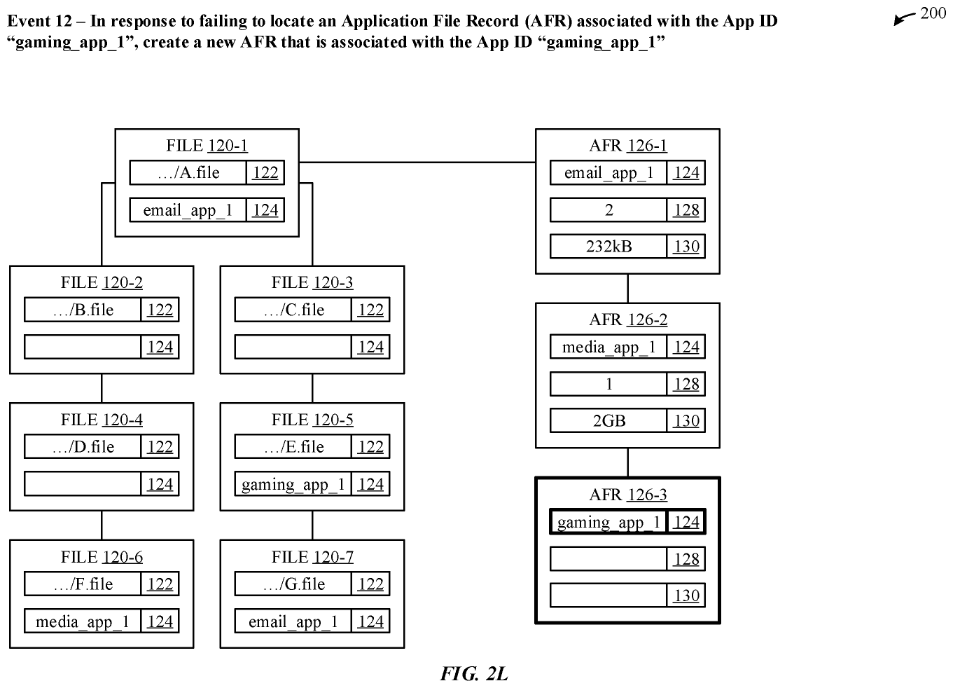

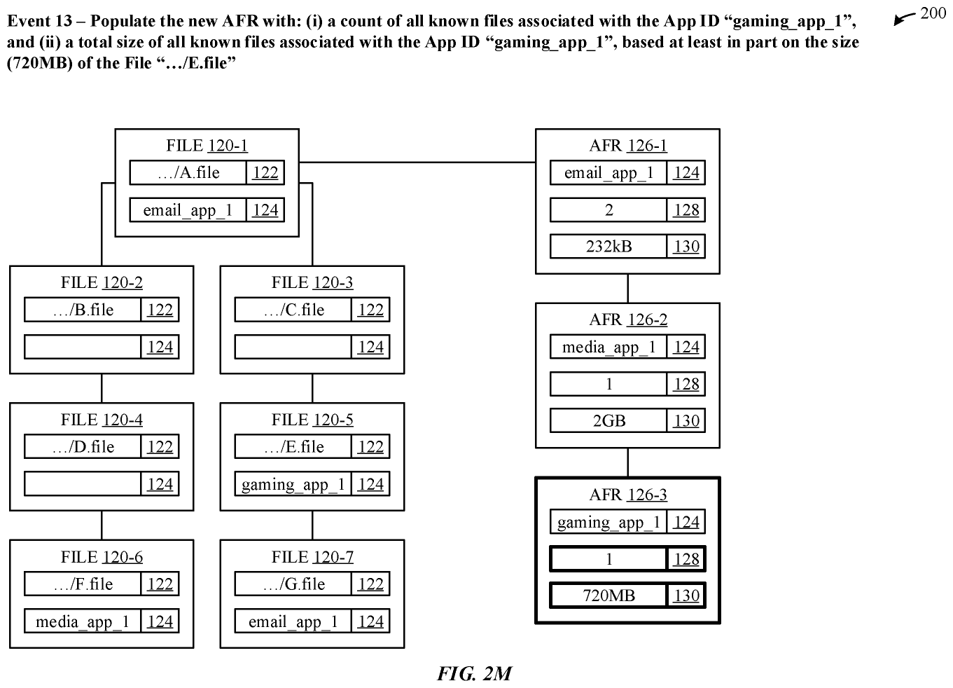

Additionally, and as illustrated in FIG. 1, the file system volume 118 can include, for each application 110, a respective application file record 126. According to some embodiments, each application file record 126 can include an application identifier 124, a file counter 128, cumulative file size information 130, and other information 132. According to some embodiments, the file system manager 114 can be configured to, in conjunction with binding an application identifier 124 to a file 120 (e.g., in conjunction with performing an I/O operation to the file 120 on behalf of the application 110, as discussed above), determine whether the file system volume 118 includes an application file record 126 that is associated with the application identifier 124. In particular, if such an application file record 126 does not exist within the file system volume 118, then the file system manager 114 can generate a new application file record 126, associate the new application file record 126 with the application identifier 124 of the application 110, and then update the file counter 128, the cumulative file size information 130, and/or other information 132 of the application file record 126 to reflect the I/O operation. Conversely, if the application file record 126 already exists within the file system volume 118, then the file system manager 114 can locate the application file record 126, and update the file counter 128, the cumulative file size information 130, and/or the other information 132 of the application file record 126 to reflect the I/O operation relative to previous I/O operations (that, based on the existence of the application file record 126, inherently already occurred). A more detailed breakdown of the manner in which the file system manager 114 manages the application file records 126 is provided below in conjunction with FIGS. 2A-2M, 3A-3D, and 4-6.

As a brief aside, it is noted that the application file records 126 can effectively be stored as files 120 within a given file system volume 118, and that they are illustrated as separate entities relative to the files 120 in the interest of simplifying this disclosure. In other words, all information of a given application file record 126 can be stored within a file 120, such that the files 120 and the application file records 126 are effectively one and the same, without departing from the scope of this disclosure.

Additionally, it is noted that the file system manager 114 can be aware of the respective operating directories of the applications 110—e.g., by maintaining a table of information that maps each application 110 to its respective operating directory-so that the tracking techniques described herein can be conditionally implemented based on whether the applications 110 attempt to interact with files 120 that are located outside of the respective operating directories of the applications 110. For example, if the file system manager 114 receives, from an application 110, a request to perform an I/O operation that interacts with a file 120 that is stored within the respective operating directory of the application 110, then the file system manager 114 can forego the tracking techniques described herein (e.g., tagging the file 120 with the application identifier 124, interfacing with the application file record 126 associated with the application 110, and so on), given the I/O operation is appropriately directed to the respective operating directory of the application 110. Conversely, if the file system manager 114 receives, from the application 110, a request to perform an I/O operation that interacts with a file 120 that is stored outside of the respective operating directory of the application 110, then the file system manager 114 can implement the tracking techniques described herein, given the I/O operation is inappropriately directed to a file 120 that is located outside of the respective operating directory of the application 110.

Additionally, it is noted that the file system manager 114 can conditionally implement the tracking techniques described herein based on the types of applications 110 issuing the I/O operations. For example, the file system manager 114 can maintain information (e.g., a table) that describes whether a given application is a first-party application (e.g., one that is native to the OS 108, one that is expressly authorized by an entity associated with the OS 108/computing device 102, etc.), a third-party application that is authorized (e.g., one that is installed using an authorized software app store application, one that is expressly authorized by an entity associated with the OS 108/computing device 102, etc.), a third-party application that is unauthorized (e.g., one that is installed through “side-loading” techniques, one that is expressly tagged as suspicious/unauthorized by an entity associated with the OS 108/computing device 102, etc.), and so on. It is noted that the foregoing examples are not meant to be limiting, and that any number of designations can be assigned to the applications 110 without departing from the scope of this disclosure.

In any case, the file system manager 114 can also implement a set of rules that define whether the tracking techniques are implemented based on the aforementioned designations of the applications 110. For example, the tracking techniques can be implemented for one or more of the designations and disabled for one or more of the designations. Moreover, the file system manager 114 can also implement a set of rules that define how the tracking techniques are implemented based on the aforementioned designations of the applications 110. For example, when the file system manager 114 implements tracking techniques for a qualifying application 110, the file system manager 114 can reference a set of rules that defines certain actions to be taken when certain conditions are satisfied. For example, if I/O operations issued by the application 110 exceed one or more thresholds (e.g., too many accesses to files 120 that are located outside of the respective operating directory of the application 110), then the file system manager 114 can cause one or more actions to be carried out that ultimately result in a management entity of the application 110 being notified. The notification(s) can include any information that assists the management entity in mitigating the issue, such as the nature of the I/O operations, the times at which they were issued, and so on.

Additionally, it is noted that the file system manager 114 can be privy to a chain of applications 110 that issue a given I/O request so that the file system manager 114 can identify the actual application 110 at issue with respect to the I/O request. For example, it may appear that a first application 110 is issuing an I/O request, when in reality, the first application 110 is issuing the I/O request on behalf of a second application 110 (and so on). When this scenario occurs, the file system manager 114 can identify the underlying application 110 that is responsible for the I/O I/O operation and establish tracking information that references the underlying application 110 (and, optionally, the other applications in the chain, if so desired). Additionally, certain applications 110 operating on the computing device 102 can be exempt from the tracking techniques discussed herein. For example, a file browser software application executing on the computing device 102 may issue I/O operations to obtain a listing of various files 120 associated with different applications 110. In this example, it may be inappropriate to establish tracking information tied to the file browser software application that suggests it is operating inappropriately.

It is noted that the foregoing examples are not meant to be limiting, and that any number of conditions, actions, etc., can be implemented to effectively identify, manage, and mitigate issues that arise with respect to applications 110 interacting with files 120 in manners that may be problematic.

Turning back now to FIG. 1, and, according to some embodiments, the storage space management application 112 can be configured to utilize the application file records 126 (and, in some cases, the files 120) to identify, process, provide, etc., information about applications 110 that have inappropriately issued I/O operations to files 120 that are located outside of the respective operating directories of the applications 110. To implement this functionality, the storage space management application 112 can be configured to analyze the application file records 126, files 120, etc., to identify applications 110 at issue and then provide relevant information based on the analyses. For example, the relevant information can be displayed within one or more user interfaces, provided to one or more entities (e.g., for further processing/utilization), and so on. According to some embodiments, the user interface(s) can be presented through a display device (not illustrated in FIG. 1) that is communicably coupled to the computing device 102. It should be appreciated that the user interface(s) can include several user interface objects such as buttons, menus, icons, and the like, without departing from the scope of this disclosure. A more detailed breakdown of the various functionalities that the storage space management application 112 can implement are provided below in conjunction with FIGS. 2A-2M, 3A-3D, and 4-6.

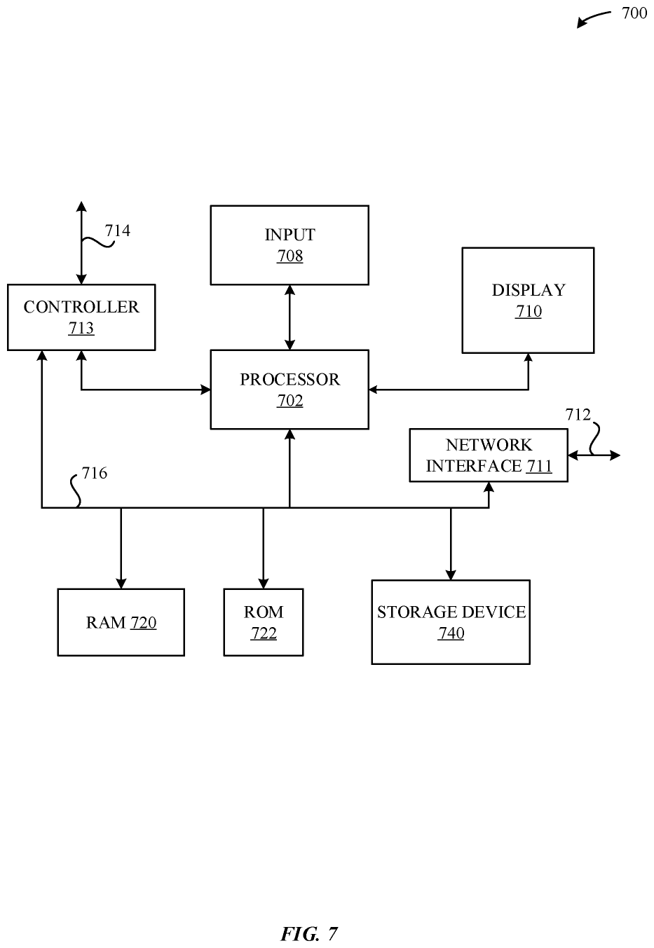

It should be understood that the various components of the computing devices illustrated in FIG. 1 are presented at a high level in the interest of simplification. For example, although not illustrated in FIG. 1, it should be appreciated that the various computing devices can include common hardware/software components that enable the above-described software entities to be implemented. A more detailed explanation of these hardware components is provided below in conjunction with FIG. 7. It should additionally be understood that the computing devices can include additional entities that enable the implementation of the various techniques described herein without departing from the scope of this disclosure. It should additionally be understood that the entities described herein can be combined or split into additional entities without departing from the scope of this disclosure. It should further be understood that the various entities described herein can be implemented using software-based or hardware-based approaches without departing from the scope of this disclosure.

Accordingly, FIG. 1 provides an overview of the manner in which the system 100 can implement the various techniques described herein, according to some embodiments. A more detailed breakdown of the manner in which these techniques can be implemented will now be provided below in conjunction with FIGS. 2A-2M, 3A-3D, and 4-6.

FIGS. 2A-2M illustrate conceptual diagrams 200 of an example sequence of interactions between applications 110, the file system manager 114, and files 120/application file records 126, according to some embodiments. As shown in FIG. 2A, a file system volume 118, during an example initial state, stores five files 120: a file 120-1 (having a path “ . . . /A.file” stored in the respective file information 122), a file 120-2 (having a path “ . . . /B.file” stored in the respective file information 122), a file 120-3 (having a path “ . . . /C.file” stored in the respective file information 122), a file 120-4 (having a path “ . . . /D.file” stored in the respective file information 122), and a file 120-5 (having a path “ . . . /E.file” stored in the respective file information 122). At the point in time of FIG. 2A, no application file records 126 are stored within the file system volume 118, which highlights that the techniques described herein can be retroactively applied against existing files 120 (as well as proactively applied against new files 120).

In any case, as shown in FIG. 2A, a first event involves the file system manager 114 receiving, from an application 110 having an application identifier 124 “email_app_1”, an I/O operation to read the file 120-1 (having the path “ . . . /A.file” stored in the respective file information 122). In turn, the file system manager 114 locates the file 120-1 within the file system volume 118, and provides the appropriate response—such as the content of the file 120-1—to the application 110. Next, as shown in FIG. 2B, a second event involves the file system manager 114 associating the file 120-1 with the application 110. In particular, the association is established by assigning the application identifier 124 “email_app_1” of the application 110 to the application identifier 124 of the file 120-1. Consequently, the file 120-1 is effectively bound to the application 110 by way of the shared application identifier 124. In this manner, the file 120-1 actively identifies the last application 110 that interacted with the file 120-1.

As a brief aside, it is noted that each file 120 is not limited to storing only a single application identifier 124. To the contrary, each file 120 can maintain a history of interactions between applications 110 and the file 120. For example, a new key/value entry can be added to a given file 120 each time an application 110 issues an I/O operation against the file 120, where the key is assigned the application identifier 124 of the application 110, and the value is assigned a timestamp (e.g., of a receipt of the I/O operation, of an execution of the I/O operation, etc.). Any additional information can be stored within the value as well, such as details about the I/O operation (e.g., the type of the I/O operation), details about operating conditions of the computing device 102 relative to the time at which the I/O operation was received, and so on.

Accordingly, at the conclusion of the second event in FIG. 2B, the file 120-1 is effectively bound to the application 110 (having the application identifier 124 “email_app_1”). However, as shown in FIG. 2B, the file system volume 118 does not yet include an application file record 126 that corresponds to the application 110 (let alone any application file records 126). This can occur, for example, when the I/O operation issued by the application 110 constitutes a first I/O operation the file system manager 114 has received from the application 110 (or any other applications 110, for that matter) relative to implementing the tracking techniques disclosed herein. Accordingly, at a third event in FIG. 2C, the file system manager 114, in response to failing to locate an application file record 126 associated with the application 110 (having the application identifier 124 “email_app_1”), creates a new application file record 126-1 that is associated with the application 110. In particular, and as shown in FIG. 2C, the file system manager 114 assigns the value “email_app_1” to the application identifier 124 of the application file record 126-1. Additionally, at a fourth event in FIG. 2D, the file system manager 114 populates the application file record 126-1 with (i) a count of all known files associated with the application 110 (having the application identifier 124 “email_app_1”), and (ii) a total size of all known files associated with the application 110 (based at least in part on the size of the file 120-1 (32 KB)). In particular, and as shown in FIG. 2D, the file system manager 114 assigns the value “1” to the file counter 128 of the application file record 126-1, which represents the total number of files that the file system manager 114 has observed the application 110 interact with (at least since the file system manager 114 began implementing the tracking techniques described herein). The file system manager 114 also assigns the value “32 kB” to the cumulative file size information 130 of the application file record 126-1, which represents the total size of all of the files 120 that the file system manager 114 has observed the application 110 interact with (at least since the file system manager 114 began implementing the tracking techniques described herein).

Additionally, and although not illustrated in FIGS. 2C-2M, it is noted that the file system manager 114 can be configured to populate the other information 132 of the application file record 126-1 where appropriate. Such information can include, for example, a count of all clone files 120 that are associated with the application 110, a cumulative size of all clone files 120 that are associated with the application 110, a cumulative size of all FS objects that the application 110 has indicated can be deleted (e.g., in the event that additional storage space within the file system volume 118 is required), a count of all I/O operations that have been issued to the file system manager 114 by the application 110, and so on. It is noted that the foregoing examples are not meant to be limiting, and that the other information 132 can store any type, form, amount, etc., of information, at any level of granularity, without departing from the scope of this disclosure. Additionally, it is noted that any of the foregoing counts, sizes, etc., can be omitted from the other information 132 if desired. However, it is noted that, when such omissions are implemented, any of the foregoing counts, sizes, etc., can instead be determined by aggregating properties stored within the files 120.

As a brief aside, it is noted that the counts, cumulative sizes, etc., described herein can be effectively maintained by the file system manager 114 based on the types of the I/O operations being issued against files 120, whether the files 120 were associated with application identifiers 124 at the time the I/O operations were issued against the files 120, and so on. For example, if the application 110 (associated with the application identifier 124 “email_application_1”) were to issue another I/O operation to read the same file 120-1, it would be inappropriate to simply increment the file counter 128 associated with the application file record 126-1 and add the file size (32 kB) of the file 120-1 to the cumulative file size information 130. Instead, the file counter 128 should remain intact (as the aforementioned read I/O operation does not increase the number of files 120 associated with the application 110), and the cumulative file size information 130 should remain intact as well (as the aforementioned read I/O operation does not modify the total size of the files 120 associated with the application 110). In another example, if the application 110 were to issue another I/O operation to write to the same file 120-1—where the write causes the size of the file 120-1 to increase by 20 kB to a total of 52 kB-then it would be appropriate to keep the file counter 128 intact (as the aforementioned write I/O operation does not increase the number of files 120 associated with the application 110), and to update the cumulative file size information 130 to reflect the new size of the file 120-1. In yet another example, if the application 110 were to issue another I/O operation to delete the same file 120-1, it would be appropriate to simply decrement the file counter 128 associated with the application file record 126-1, and to reduce the cumulative file size information 130 by the size of the file 120-1. In any case, those having skill in the art will appreciate that the file system manager 114 can access all information that is needed to effectively maintain the application file records 126 relative to the I/O operations that are received from the applications 110.

Accordingly, at the conclusion of FIG. 2D, a single application file record 126-1 exists within the file system volume 118 and is associated with the application 110 (having the application identifier 124 “email_app_1”), and the single file 120-1 is associated with the application 110 (by way of the application identifier 124 “email_app_1”). Turning now to FIG. 2E, a fifth event involves the file system manager 114 receiving, from an application 110 having an application identifier 124 “media_app_1”, an I/O operation to create a new file 120-6. “ . . . /F.file”. In response, the file system manager 114 creates the new file 120-6 (e.g., by performing one or more write operations that establish the file 120-6, by updating the file information 122 of the file 120-6 as/where appropriate, etc.), and associates the new file 120-6 with the application 110 (by assigning “media_app_1” to the application identifier 124 of the file 120-6).

Accordingly, at the conclusion of the fifth event in FIG. 2E, the file 120-6 is effectively bound to the application 110 (having the application identifier 124 “media_app_1”). However, as shown in FIG. 2E, the file system volume 118 does not yet include an application file record 126 that corresponds to the application 110. Accordingly, at a sixth event in FIG. 2F, the file system manager 114, in response to failing to locate an application file record 126 associated with the application 110 (having the application identifier 124 “media_app_1”), creates a new application file record 126-2 that is associated with the application 110. In particular, and as shown in FIG. 2F, the file system manager 114 assigns the value “media_app_1” to the application identifier 124 of the application file record 126-2. Additionally, at a seventh event in FIG. 2G, the file system manager 114 populates the application file record 126-2 with (i) a count of all known files associated with the application 110 (having the application identifier 124 “media_app_1”), and (ii) a total size of all known files associated with the application 110 (based at least in part on the size (2 GB) of the file 120-6). In particular, and as shown in FIG. 2G, the file system manager 114 assigns the value “1” to the file counter 128 of the application file record 126-2, which represents the total number of files that the file system manager 114 has observed the application 110 interact with (at least since the file system manager 114 began implementing the tracking techniques described herein). The file system manager 114 also assigns the value “2 GB” to the cumulative file size information 130 of the application file record 126-2, which represents the total size of all of the files 120 that the file system manager 114 has observed the application 110 interact with (at least since the file system manager 114 began implementing the tracking techniques described herein).

Accordingly, at the conclusion of FIG. 2G, two application file records 126 exist within the file system volume 118, and two files 120 are associated with different ones of the applications 110. Turning now to FIG. 2H, an eighth event involves the file system manager 114 receiving, from the application 110 having the application identifier 124 “email_app_1”, an I/O operation to create a new file 120-7 “ . . . /G.file”. In response, the file system manager 114 creates the new file 120-7 (e.g., by performing one or more write operations that establish the file 120-7, by updating the file information 122 of the file 120-7 as/where appropriate, etc.), and associates the new file 120-7 with the application 110 (by assigning “email_app_1” to the application identifier 124 of the file 120-7).

Accordingly, at the conclusion of the eighth event in FIG. 2H, the file 120-7 is effectively bound to the application 110 (having the application identifier 124 “email_app_1”). Additionally, and per the previous events that occurred in conjunction with FIGS. 2A-2D, the file system volume 118 already includes an application file record 126-1 that corresponds to the application 110. Accordingly, at a ninth event in FIG. 2I, the file system manager 114 updates the application file record 126-1 with (i) a count of all known files associated with the application 110 (having the application identifier 124 “email_app_1”), and (ii) a total size of all known files associated with the application 110 (based at least in part on the size (200 kB) of the file 120-7). In particular, and as shown in FIG. 2I, the file system manager 114 assigns the value “2” to the file counter 128 of the application file record 126-1, which represents the total number of files that the file system manager 114 has observed the application 110 interact with (at least since the file system manager 114 began implementing the tracking techniques described herein). The file system manager 114 also assigns the value “232 kB” to the cumulative file size information 130 of the application file record 126-1, which represents the total size of all of the files 120 that the file system manager 114 has observed the application 110 interact with (at least since the file system manager 114 began implementing the tracking techniques described herein). In particular, the value “232 kb” represents the sum of the sizes of the file 120-1 (32 kb) and the file 120-7 (200 kB).

Accordingly, at the conclusion of the ninth event in FIG. 2I, two application file records 126 exist within the file system volume 118, and three files 120 are associated with different ones of the applications 110. Turning now to FIG. 2J, a tenth event involves the file system manager 114 receiving, from an application 110 having the application identifier 124 “gaming_app_1”, an I/O operation to update the file 120-5 “ . . . /E.file”. In response, the file system manager 114 updates the new file 120-5 (e.g., by performing one or more I/O operations to the underlying content of the file 120-7, by updating the file information 122 of the file 120-5 as/where appropriate, etc.), and at an eleventh event in FIG. 2K, associates the file 120-5 with the application 110 (by assigning “gaming_app_1” to the application identifier 124 of the file 120-5).

Accordingly, at the conclusion of the eleventh event in FIG. 2K, the file 120-5 is effectively bound to the application 110 (having the application identifier 124 “gaming_app_1”). However, as shown in FIG. 2K, the file system volume 118 does not yet include an application file record 126 that corresponds to the application 110. Accordingly, at twelfth event in FIG. 2L, the file system manager 114, in response to failing to locate an application file record 126 associated with the application 110 (having the application identifier 124 “gaming_app_1”), creates a new application file record 126-3 that is associated with the application 110. In particular, and as shown in FIG. 2L, the file system manager 114 assigns the value “gaming_app_1” to the application identifier 124 of the application file record 126-3. Additionally, at a thirteenth event in FIG. 2M, the file system manager 114 populates the application file record 126-3 with (i) a count of all known files associated with the application 110 (having the application identifier 124 “gaming_app_1”), and (ii) a total size of all known files associated with the application 110 (based at least in part on the size (720 MB) of the file-5). In particular, and as shown in FIG. 2M, the file system manager 114 assigns the value “1” to the file counter 128 of the application file record 126-3, which represents the total number of files that the file system manager 114 has observed the application 110 interact with (at least since the file system manager 114 began implementing the tracking techniques described herein). The file system manager 114 also assigns the value “720 MB” to the cumulative file size information 130 of the application file record 126-3, which represents the total size of all of the files 120 that the file system manager 114 has observed the application 110 interact with (at least since the file system manager 114 began implementing the tracking techniques described herein).

Accordingly, FIGS. 2A-2M illustrate conceptual diagrams 200 of an example sequence of interactions between applications 110, the file system manager 114, and files 120/application file records 126, according to some embodiments. As described herein, the application file records 126 enable the file system manager 114 to effectively track interactions between the applications 110 and files 120 (particularly, the files 120 that are located outside of the respective operating directories of the applications 110, as described herein). The application file records 126 also enable statistical overviews of the interactions to be maintained on an ongoing basis, thereby enabling such statistical overviews to be efficiently retrieved, further-analyzed, and so on. As a result, when such statistical overviews are requested by entities-such as the storage space management application 112, the OS 108, and/or other entities (executing on the computing device 102, on authorized remote/server computing devices, etc.)—the file system manager 114 is not required to parse the files 120 to generate the statistical overview, which otherwise would be inefficient and necessary without the application file records 126.

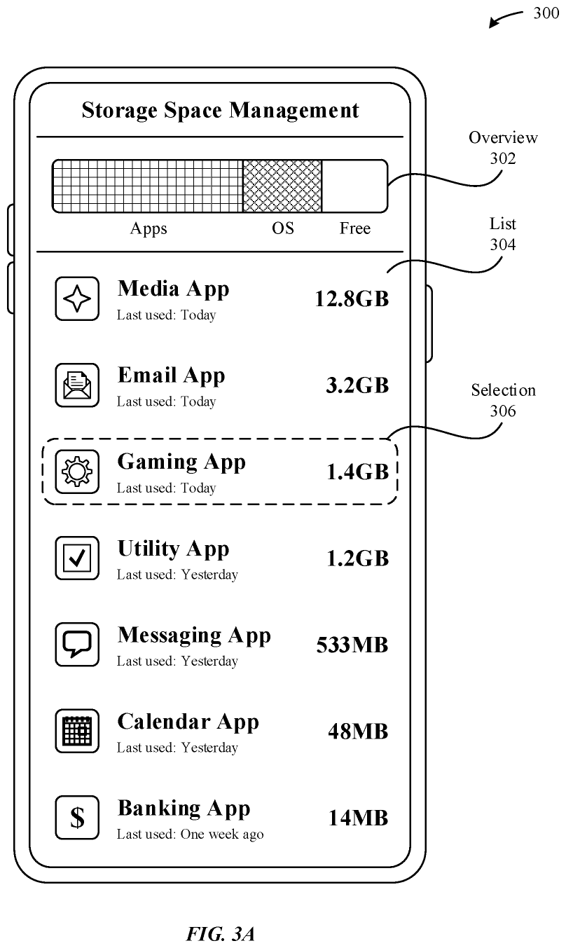

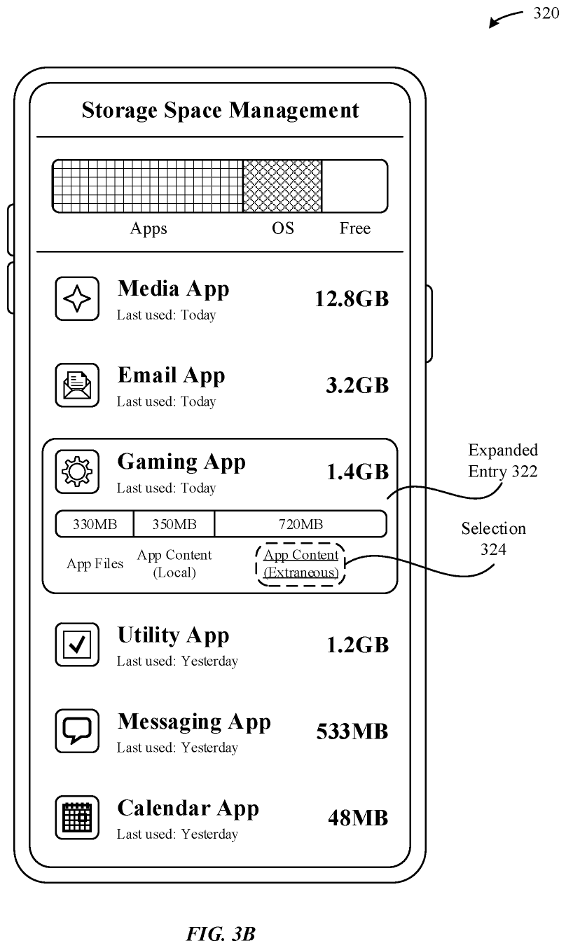

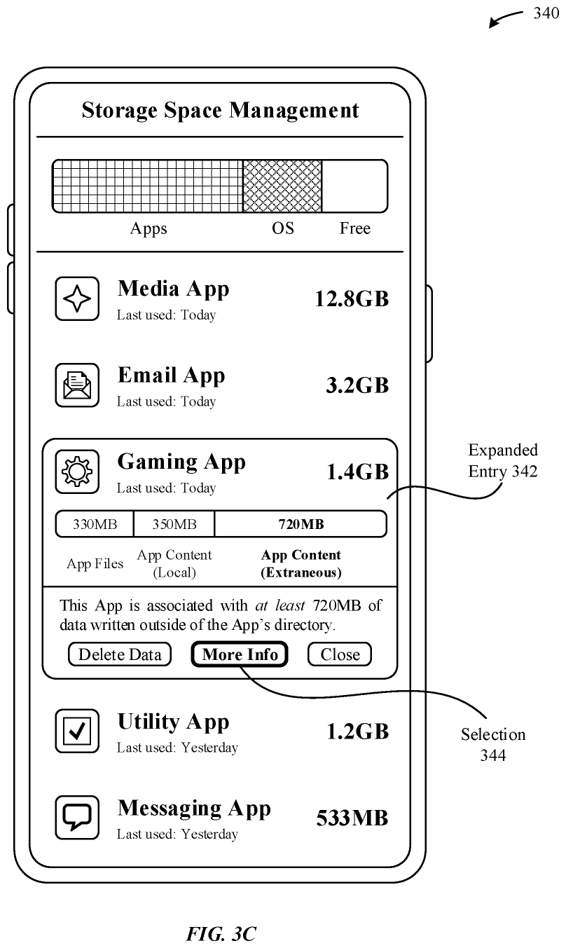

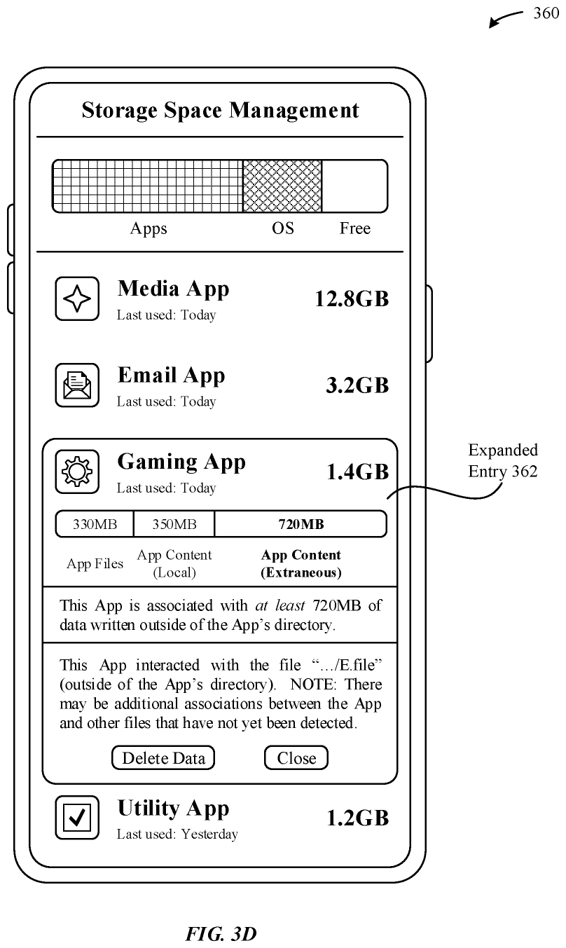

FIGS. 3A-3D illustrate conceptual diagrams of example user interfaces that can be provided by the storage space management application 112, according to some embodiments. In particular, and as shown in FIG. 3A, a user interface 300 can include an overview 302 of how storage space within the storage device 116 is being utilized by applications 110 and the OS 108. It is noted that the overview 302 illustrated in FIG. 3A is not meant to be limiting. To the contrary, the overview 302 can represent storage space consumption by any number, type, etc., of entities, at any level of granularity, without departing from the scope of this disclosure. Additionally, and as shown in FIG. 3A, the user interface 300 can include a list 304 of applications 110 that are installed on the computing device 102 (e.g., sorted by storage space consumed, in descending order). For example, the entry for the application named “Media App” can represent the application 110 having the application identifier 124 “media_app_1” described above in conjunction with FIGS. 2A-2M, the entry for the application named “Email App” can represent the application 110 having the application identifier 124 “email_app_1” described above in conjunction with FIGS. 2A-2M, and the entry for the application named “Gaming App” can represent the application 110 having the application identifier 124 “gaming_app_1” described above in conjunction with FIGS. 2A-2M.

As shown in FIG. 3A, the storage space management application 112 receives a selection 306 that corresponds to the entry for the application named “Gaming App”. In turn, and as shown in FIG. 3B, the storage space management application 112 displays a user interface 320, which includes an expanded entry 322 for the application named “Gaming App”. Here, and as shown in FIG. 3B, the expanded entry 322 includes a breakdown of the total size of the files 120 that make up the application itself (“App Files”), a breakdown of the total size of the files 120 that are managed/accessed by the application within its respective operating directory (“App Content (Local)”), and a breakdown of the total size of the files 120 that are managed/accessed by the application outside of its respective operating directory (“App Content (Extraneous)”).

As shown in FIG. 3B, the storage space management application 112 receives a selection 324 of an option that enables additional information to be displayed about the “App Content (Extraneous)” information (i.e., the total size of the files 120 that are managed/access by the application outside of its respective operating directory). In turn, and as shown in FIG. 3C, the storage space management application 112 displays a user interface 340, which includes an expanded entry 342 for the application named “Gaming App”. Here, and as shown in FIG. 3C, the expanded entry 342 includes a description of the amount of data that, at least so far, the file system manager 114 has detected the application named “Gaming App” has interacted with. The expanded entry 342 also includes options to delete the data, to obtain more information about the issue, and to close the expanded entry 342. It is noted that the amount of data—i.e., 720 MB—corresponds to the events described above in conjunction with FIGS. 2J-2M, which involved the file system manager 114 detecting a request from the application 110 (having the application identifier 124 “gaming_app_1”) to read the file 120-5, which has a size of 720 MB, and which is stored outside of the respective operating directory of the application 110.

Additionally, as shown in FIG. 3C, the storage space management application 112 receives a selection 344 of an option that enables additional information to be displayed about what is being shown via the expanded entry 342. In turn, and as shown in FIG. 3D, the storage space management application 112 displays a user interface 360, which includes an expanded entry 362 for the application named “Gaming App”. Here, and as shown in FIG. 3D, the expanded entry 362 elaborates on what is displayed in the expanded entry 342. In particular, the expanded entry 362 provides detailed file information 122 (e.g., the path “ . . . /E.file”) associated with the file 120 at issue, as well as a warning that the application named “Gaming App” may also be associated with files 120 that the file system manager 114 has not yet detected. It is noted that the path (as well as any other file 120 information) can be obtained by parsing the file system volume 118 for files 120 that are tagged with the application identifier 124 of the application 110. The expanded entry 362 also includes options to delete the data and to close the expanded entry 342.

Accordingly, FIGS. 3A-3D illustrate conceptual diagrams of example user interfaces that can be provided by the storage space management application 112, according to some embodiments. In particular, and as discussed herein, the storage space management application 112 can be configured to interface with the file system manager 114 to obtain tracking information that enables the storage space management application 112 to provide the user interfaces illustrated in FIGS. 3A-3D, to provide tracking information to other entities, and so on. It is noted, however, that other entities may be permitted to interface directly with the file system manager 114 to obtain the tracking information, where appropriate. Additionally, it is noted that the user interfaces illustrated in FIGS. 3A-3D are merely exemplary and not meant to be limiting. To the contrary, any type, form, etc., of user interface, at any level of granularity, can be implemented to convey, expand on, etc., the tracking information discussed herein, without departing from the scope of this disclosure.

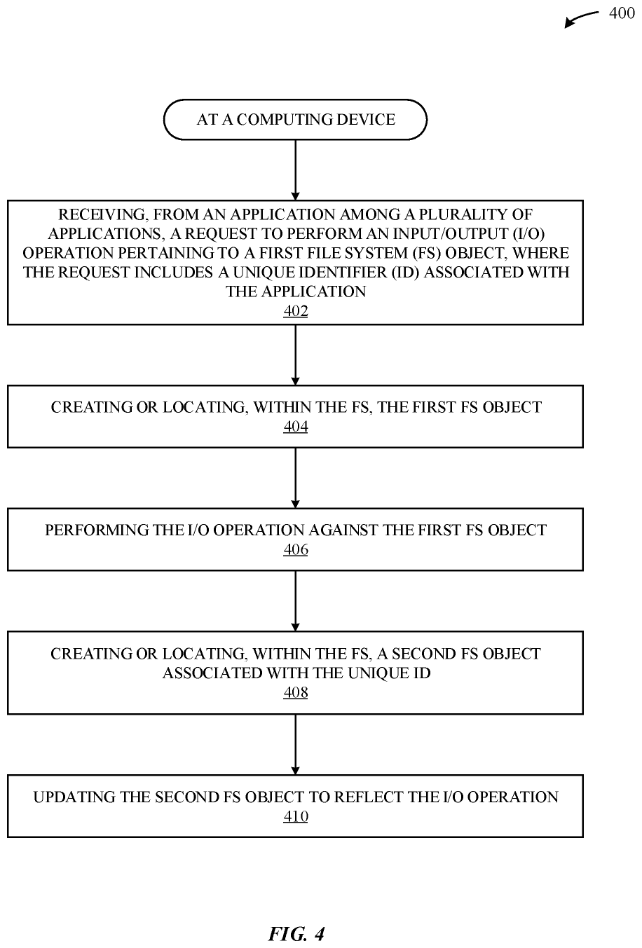

Additionally, FIGS. 4-6 provide high-level overviews of the techniques discussed herein, which can be implemented by the file system manager 114, the storage space management application 112, and/or other entities.

FIG. 4 illustrates a method 400 for tracking file system utilization by a plurality of applications, according to some embodiments. According to some embodiments, the method 400 can be implemented by the file system manager 114. As shown in FIG. 4, the method 400 begins at step 402, where the file system manager 114 receives, from an application among a plurality of applications, a request to perform an I/O operation pertaining to a first FS object, where the request includes a unique ID associated with the application (e.g., as described above in conjunction with FIGS. 2A-2M). At step 404, the file system manager 114 creates or locates, within the FS, the first FS object (e.g., as also described above in conjunction with FIGS. 2A-2M).

At step 406, the file system manager 114 performs the I/O operation against the first FS object (e.g., as also described above in conjunction with FIGS. 2A-2M). At step 408, the file system manager 114 creates or locates, within the FS, a second FS object associated with the unique ID (e.g., as also described above in conjunction with FIGS. 2A-2M). At step 410, the file system manager 114 updates the second FS object to reflect the I/O operation (e.g., as also described above in conjunction with FIGS. 2A-2M).

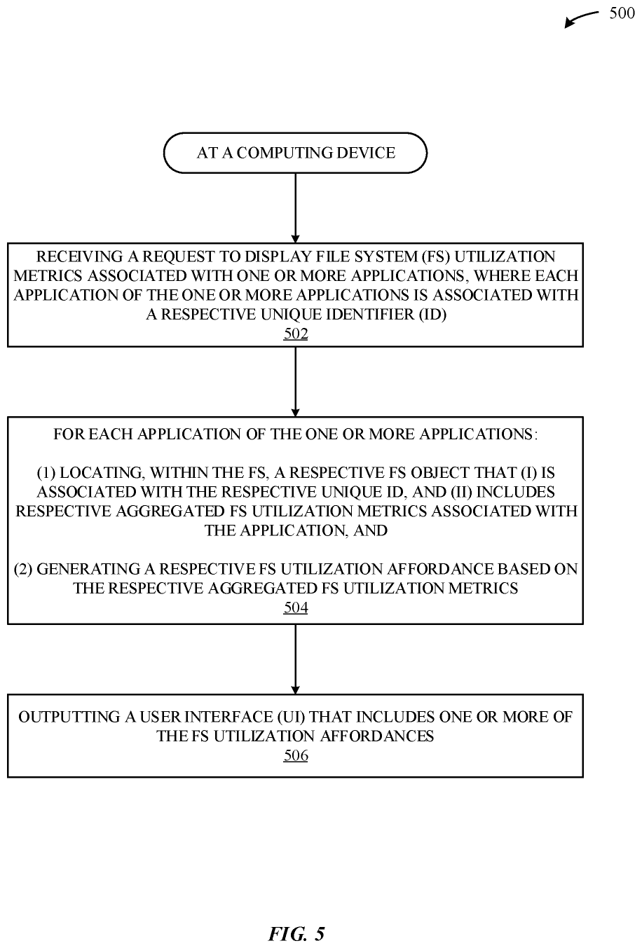

FIG. 5 illustrates a method 500 for observing FS utilization by one or more applications, according to some embodiments. According to some embodiments, the method 500 can be implemented by the storage space management application 112/the file system manager 114. As shown in FIG. 5, the method 500 begins at step 502, where the storage space management application 112 receives a request to display FS utilization metrics associated with one or more applications, where each application of the one or more applications is associated with a respective unique ID (e.g., as described above in conjunction with FIGS. 2A-2M and 3A-3D).

At step 504, the storage space management application 112 performs the following steps for each application of the one or more applications: (1) locating, within the FS, a respective FS object that (i) is associated with the respective unique id, and (ii) includes respective aggregated FS utilization metrics associated with the application, and (2) generating a respective FS utilization affordance based on the respective aggregated FS utilization metrics (e.g., as described above in conjunction with FIGS. 2A-2M and 3A-3D).

At step 506, the storage space management application 112 outputs a user interface (UI) that includes one or more of the FS utilization affordances (e.g., as described above in conjunction with FIGS. 2A-2M and 3A-3D).

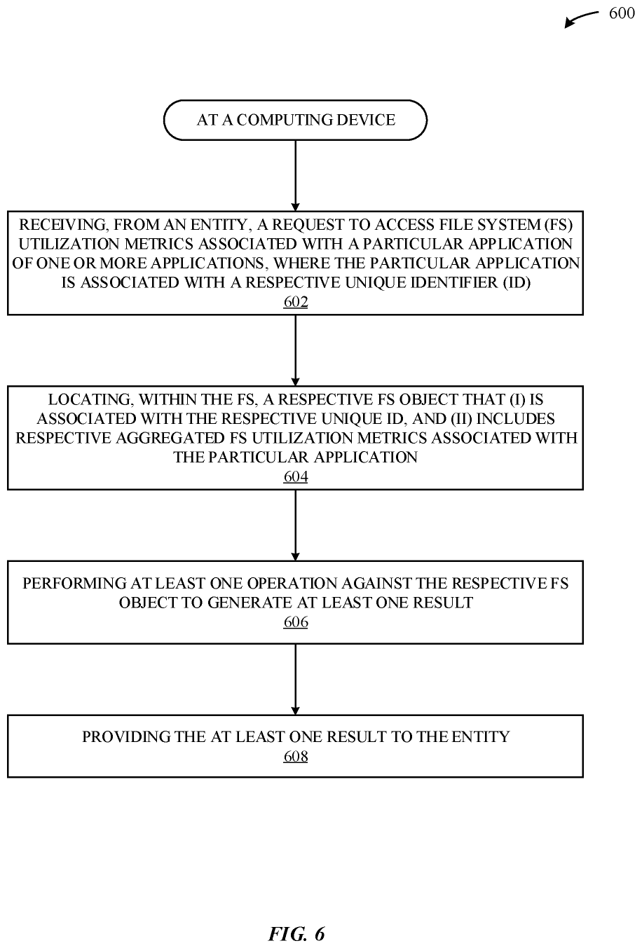

FIG. 6 illustrates a method 600 for analyzing FS utilization by one or more applications, according to some embodiments. According to some embodiments, the method 600 can be implemented by the storage space management application 112/the file system manager 114. As shown in FIG. 6, the method 600 begins at step 602, where the storage space management application 112 receives, from an entity, a request to access FS utilization metrics associated with a particular application of one or more applications, where the particular application is associated with a respective unique ID (e.g., as described above in conjunction with FIGS. 2A-2M and 3A-3D).

At step 604, the storage space management application 112 locates, within the FS, a respective FS object that (i) is associated with the respective unique id, and (ii) includes respective aggregated FS utilization metrics associated with the particular application (e.g., as also described above in conjunction with FIGS. 2A-2M and 3A-3D). At step 606, the storage space management application 112 performs at least one operation against the respective FS object to generate at least one result (e.g., as also described above in conjunction with FIGS. 2A-2M and 3A-3D). At step 608, the storage space management application 112 provides the at least one result to the entity (e.g., as described above in conjunction with FIGS. 2A-2M and 3A-3D).

FIG. 7 illustrates a detailed view of a computing device 700 that can be used to implement the various components described herein, according to some embodiments. In particular, the detailed view illustrates various components that can be included in the computing device 102 described above in conjunction with FIG. 1.

As shown in FIG. 7, the computing device 700 can include a processor 702 that represents a microprocessor or controller for controlling the overall operation of computing device 700. The computing device 700 can also include a user input device 708 that allows a user of the computing device 700 to interact with the computing device 700. For example, the user input device 708 can take a variety of forms, such as a button, keypad, dial, touch screen, audio input interface, visual/image capture input interface, input in the form of sensor data, etc. Furthermore, the computing device 700 can include a display 710 (screen display) that can be controlled by the processor 702 to display information to the user. A data bus 716 can facilitate data transfer between at least a storage device 740, the processor 702, and a controller 713. The controller 713 can be used to interface with and control different equipment through and equipment control bus 714. The computing device 700 can also include a network/bus interface 711 that couples to a data link 712. In the case of a wireless connection, the network/bus interface 711 can include a wireless transceiver.

The computing device 700 also includes a storage device 740, which can comprise a single disk or a plurality of disks (e.g., SSDs), and includes a storage management module that manages one or more partitions within the storage device 740. In some embodiments, storage device 740 can include flash memory, semiconductor (solid state) memory or the like. The computing device 700 can also include a Random-Access Memory (RAM) 720 and a Read-Only Memory (ROM) 722. The ROM 722 can store programs, utilities, or processes to be executed in a non-volatile manner. The RAM 720 can provide volatile data storage, and stores instructions related to the operation of the computing devices described herein.

The various aspects, embodiments, implementations, or features of the described embodiments can be used separately or in any combination. Various aspects of the described embodiments can be implemented by software, hardware or a combination of hardware and software. The described embodiments can also be embodied as computer readable code on a computer readable medium. The computer readable medium is any data storage device that can store data that can be read by a computer system. Examples of the computer readable medium include read-only memory, random-access memory, CD-ROMs, DVDs, magnetic tape, hard disk drives, solid state drives, and optical data storage devices. The computer readable medium can also be distributed over network-coupled computer systems so that the computer readable code is stored and executed in a distributed fashion.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It will be apparent to one of ordinary skill in the art that many modifications and variations are possible in view of the above teachings.

As described herein, one aspect of the present technology is the gathering and use of data available from various sources to improve user experiences. The present disclosure contemplates that in some instances, this gathered data may include personal information data that uniquely identifies or can be used to contact or locate a specific person. Such personal information data can include demographics data, location-based data, telephone numbers, email addresses, home addresses, data or records relating to a user's health or level of fitness (e.g., vital signs measurements, medication information, exercise information), date of birth, smart home activity, or any other identifying or personal information. The present disclosure recognizes that the use of such personal information data, in the present technology, can be used to the benefit of users.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, the present technology can be configured to allow users to select to “opt in” or “opt out” of participation in the collection of personal information data during registration for services or anytime thereafter. In another example, users can select to provide only certain types of data that contribute to the techniques described herein. In addition to providing “opt in” and “opt out” options, the present disclosure contemplates providing notifications relating to the access or use of personal information. For instance, a user may be notified that their personal information data may be accessed and then reminded again just before personal information data is accessed.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data.

What is claimed is:

1. A method for tracking file system (FS) utilization by a plurality of applications, the method comprising, by a computing device on which the FS is implemented:
receiving, from an application among the plurality of applications, a request to perform an input/output (I/O) operation pertaining to a first FS object, wherein the request includes a unique identifier (ID) associated with the application;
creating or locating, within the FS, the first FS object;
performing the I/O operation against the first FS object;
creating or locating, within the FS, a second FS object associated with the unique ID; and
updating the second FS object to reflect the I/O operation.

2. The method of claim 1, further comprising, in response to determining that the first FS object is not associated with the unique ID:
associating the first FS object with the unique ID.

3. The method of claim 1, wherein the second FS object is additionally associated with:
a first count of all FS objects in the FS that are associated with the unique ID wherein the first count is associated with a second count of all FS clone objects that are associated with the unique ID;
a first cumulative size of all FS objects in the FS that are associated with the unique ID;
a second cumulative size of all FS clone objects in the FS that are associated with the unique ID; or
some combination thereof.

4. The method of claim 3, wherein updating the second FS object to reflect the I/O operation comprises updating the first count, the first cumulative size, the second count, the second cumulative size, the third total size, the third count, or some combination thereof.

5. The method of claim 1, wherein the I/O operation pertaining to the first FS object comprises:
a write operation to establish the first FS object within the FS and/or to update the first FS object within the FS;
a read operation to read the first FS object;
a clone operation to clone the first FS object;
a truncate operation to truncate the first FS object;
a rename operation to rename the first FS object; or
some combination thereof.

6. The method of claim 1, wherein the unique ID comprises an output of a hash function applied against a unique application ID associated with the application.

7. The method of claim 1, wherein the first and second FS objects are encrypted using an encryption key that is accessible to the FS but inaccessible to the application.

8. A method for observing file system (FS) utilization by one or more applications, the method comprising, by a computing device on which the FS is implemented:
receiving a request to display FS utilization metrics associated with the one or more applications, wherein each application of the one or more applications is associated with a respective unique identifier (ID);
for each application of the one or more applications:
locating, within the FS, a respective FS object that (i) is associated with the respective unique ID, and (ii) includes respective aggregated FS utilization metrics associated with the application, and
generating a respective FS utilization affordance based on the respective aggregated FS utilization metrics; and
outputting a user interface (UI) that includes one or more of the FS utilization affordances.

9. The method of claim 8, wherein each FS utilization affordance indicates, based on the respective unique ID associated with the application that corresponds to the FS utilization affordance, an entity through which the application was installed on the computing device.

10. The method of claim 9, wherein, for each application of the one or more applications, the respective aggregated FS utilization metrics associated with the application include:
a respective first count of all FS objects in the FS that are associated with the unique ID, wherein the first count is associated with a second count of all FS clone objects that are associated with the unique ID;
a respective first cumulative size of all FS objects in the FS that are associated with the respective unique ID of the application;
a respective second cumulative size of all FS clone objects in the FS that are associated with the respective unique ID of the application; or
some combination thereof.

11. The method of claim 10, wherein the one or more FS utilization affordances are sorted within the UI based on the first counts, the first cumulative sizes, the second counts, the second cumulative sizes, the third total sizes, the third counts, or some combination thereof.

12. The method of claim 11, further comprising, in response to identifying, for at least one application of the one or more applications, that the respective first count satisfies a threshold:
providing, to a managing entity associated with the at least one application, an indication of at least the respective first count.

13. The method of claim 9, further comprising:
receiving a second request to provide supplemental information relative to a particular application that corresponds to one of the one or more FS utilization affordances;
obtaining the supplemental information; and
updating the UI to display the supplemental information.

14. The method of claim 13, wherein obtaining the supplemental information comprises:
parsing the FS to identify at least one FS object that (i) is associated with the respective unique ID of the particular application, and (ii) comprises respective file information written by the particular application; and
generating the supplemental information based on the respective file information.

15. A method for analyzing file system (FS) utilization by one or more applications, the method comprising, by a computing device on which the FS is implemented:
receiving, from an entity, a request to access FS utilization metrics associated with a particular application of the one or more applications, wherein the particular application is associated with a respective unique identifier (ID);
locating, within the FS, a respective FS object that (i) is associated with the respective unique ID, and (ii) includes respective aggregated FS utilization metrics associated with the particular application;
performing at least one operation against the respective FS object to generate at least one result; and
providing the at least one result to the entity.

16. The method of claim 15, wherein the at least one result comprises:
at least a portion of a user interface that reflects at least one aspect of the at least one result;
at least one notification that reflects the at least one aspect;
at least one indication of malware presence on the computing device;
at least one billing event; or
some combination thereof.

17. The method of claim 16, wherein the at least one notification indicates that the particular application is issuing input/output (I/O) operations that fall outside of a respective designated area within the FS to which the particular application is permitted to issue I/O operations.

18. The method of claim 15, further comprising:
parsing the FS to identify at least one FS object that (i) is associated with the respective unique ID, and (ii) comprises respective file information written by the particular application; and
generating supplemental information based on the respective file information.

19. The method of claim 15, wherein the at least one result includes:
a respective first count of all FS objects in the FS that are associated with the unique ID, wherein the first count is associated with a second count of all FS clone objects that are associated with the unique ID;
a respective first cumulative size of all FS objects in the FS that are associated with the respective unique ID of the particular application;
a respective second cumulative size of all FS clone objects in the FS that are associated with the respective unique ID of the particular application; or
some combination thereof.

20. The method of claim 15, wherein the entity comprises:
a native application executing on the computing device, or
a third-party application executing on the computing device.
